(19) United States
(12) Patent Application Publication
(10) Pub. No.: US 2014/0159851 A1
(43) Pub. Date: Jun. 12, 2014

(54) INDUCTOR DEVICE, METHOD FOR MANUFACTURING THE SAME, AND PRINTED WIRING BOARD

(71) Applicant: IBIDEN CO., LTD., Ogaki-shi (JP)

(72) Inventors: Yasuhiko MANO, Ogaki-shi (JP); Kazuhiro Yoshikawa, Ogaki-shi (JP); Toshimasa Yano, Ogaki-shi (JP); Takashi Kariya, Ogaki-shi (JP)

(73) Assignee: IBIDEN CO., LTD., Ogaki-shi (JP)

(21) Appl. No.: 14/103,010

(22) Filed: Dec. 11, 2013

(30) Foreign Application Priority Data
Dec. 10, 2012 (JP) 2012-269660

(51) Int. Cl. H01F 27/28; H01F 41/02

(52) U.S. Cl. CPC H01F 27/2804; H01F 41/02
USPC 336/200; 29/602.1

(57) ABSTRACT

An inductor device has a core base, and an inductor structure including a first conductive pattern formed on a first surface side of the core base, a second conductive pattern formed on a second surface side of the core base on the opposite side with respect to the first surface side of the core base, and a through-hole conductor formed through the core base such that the through-hole conductor is connecting the first conductive pattern and the second conductive pattern. The core base includes a magnetic material layer including a magnetic material, and the magnetic material layer of the core base is positioned adjacent to at least a portion of the periphery of the inductor structure.

### CROSS-REFERENCE TO RELATED APPLICATIONS

The present application is based upon and claims the benefit of priority to Japanese Patent Application No. 2012-269660, filed Dec. 10, 2012, the entire contents of which are incorporated herein by reference.

### BACKGROUND OF THE INVENTION

### Field of the Invention

The present invention relates to an inductor device and a printed wiring board containing the inductor device.

### Description of Background Art

JP 2010-123879 A describes a coil structure having multiple coils and a magnetic core arranged in the center of each coil and divided by multiple columnar parts extending in a direction perpendicular to the coil. The entire contents of this publication are incorporated herein by reference.

### SUMMARY OF THE INVENTION

According to one aspect of the present invention, an inductor device has a core base, and an inductor structure including a first conductive pattern formed on a first surface side of the core base, a second conductive pattern formed on a second surface side of the core base on the opposite side with respect to the first surface side of the core base, and a through-hole conductor formed through the core base such that the through-hole conductor is connecting the first conductive pattern and the second conductive pattern. The core base includes a magnetic material layer including a magnetic material, and the magnetic material layer of the core base is positioned adjacent to at least a portion of the periphery of the inductor structure.

According to another aspect of the present invention, a method for manufacturing an inductor device includes preparing a magnetic material layer including a magnetic material, forming a penetrating hole through the magnetic material layer, filling a filler material into the penetrating hole, forming a first insulation layer on a first surface of the magnetic material layer, forming a second insulation layer on a second surface of the magnetic material layer on the opposite side of the first surface of the magnetic material layer such that a core base including the first insulation layer, the magnetic material layer and the second insulation layer is formed, forming a penetrating hole penetrating through the first insulation layer, the filler material filling the penetrating hole formed through the magnetic material layer, and the second insulation layer, forming a first conductive pattern on a first surface side of the core base, forming a second conductive pattern on a second surface side of the core base on the opposite side with respect to the first surface side of the core base, and forming a through-hole conductor in the penetrating hole formed through the core base such that an inductor structure including the first conductive pattern, the second conductive pattern and the through-hole conductor connecting the first conductive pattern and the second conductive pattern is formed.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1A and 1B are cross-sectional views showing an inductor device according to a first embodiment of the present invention;

FIGS. 2A-2C are plan views of the inductor component of the first embodiment, and FIG. 2B is a side view of the same;

FIGS. 3A-3C are process drawings showing a method for manufacturing the inductor device according to the first embodiment;

FIGS. 4A-4E are process drawings showing the method for manufacturing the inductor device according to the first embodiment;

FIGS. 5A-5D are process drawings showing the method for manufacturing the inductor device according to the first embodiment;

FIGS. 6A-6D are process drawings showing the method for manufacturing the inductor device according to the first embodiment;

FIGS. 7A and 7B are process drawings showing the method for manufacturing the inductor device according to the first embodiment;

FIG. 8 is a cross-sectional view of a printed wiring board into which the inductor device according to the first embodiment is built;

FIG. 9 is a cross-sectional view of a printed wiring board on which the inductor device according to the first embodiment is mounted;

FIGS. 10A and 10B are cross-sectional views showing an inductor device according to a second embodiment of the present invention;

FIGS. 11A-11D are process drawings showing a method for manufacturing the inductor device according to the second embodiment;

FIGS. 12A-12C are process drawings showing the method for manufacturing the inductor device according to the second embodiment;

FIGS. 13A-13D are process drawings showing the method for manufacturing the inductor device according to the second embodiment;

FIGS. 14A-14D are process drawings showing the method for manufacturing the inductor device according to the second embodiment;

FIGS. 15A and 15B are process drawings showing the method for manufacturing the inductor device according to the second embodiment;

FIGS. 16A and 16B are cross-sectional views showing an inductor device according to a third embodiment of the present invention;

FIGS. 17A-17D are process drawings showing a method for manufacturing the inductor device according to the third embodiment;

FIG. 18 is process drawing showing the method for manufacturing the inductor device according to the third embodiment;

FIGS. 19A and 19B are cross-sectional views showing an inductor device according to a fourth embodiment of the present invention;

FIGS. 20A and 20B are plan views, respectively, of the core base before and after a magnetic substance is accommodated;

FIG. 21A is a plan view of an inductor component 30, and FIG. 21B is a side view of the same;

FIGS. 22A-22E are process drawings showing a method for manufacturing the inductor device according to the fourth embodiment;

FIGS. 23A and 23B are process drawings showing the method for manufacturing the inductor device according to the fourth embodiment;

FIG. 24 is a cross-sectional view showing an inductor device according to a fifth embodiment of the present invention; and

FIGS. 25A and 25B are process drawings showing a method for manufacturing an inductor device according to a modification of the first embodiment of the present invention.

### DETAILED DESCRIPTION OF THE EMBODIMENTS

The embodiments will now be described with reference to the accompanying drawings, wherein like reference numerals designate corresponding or identical elements throughout the various drawings.

### First Embodiment

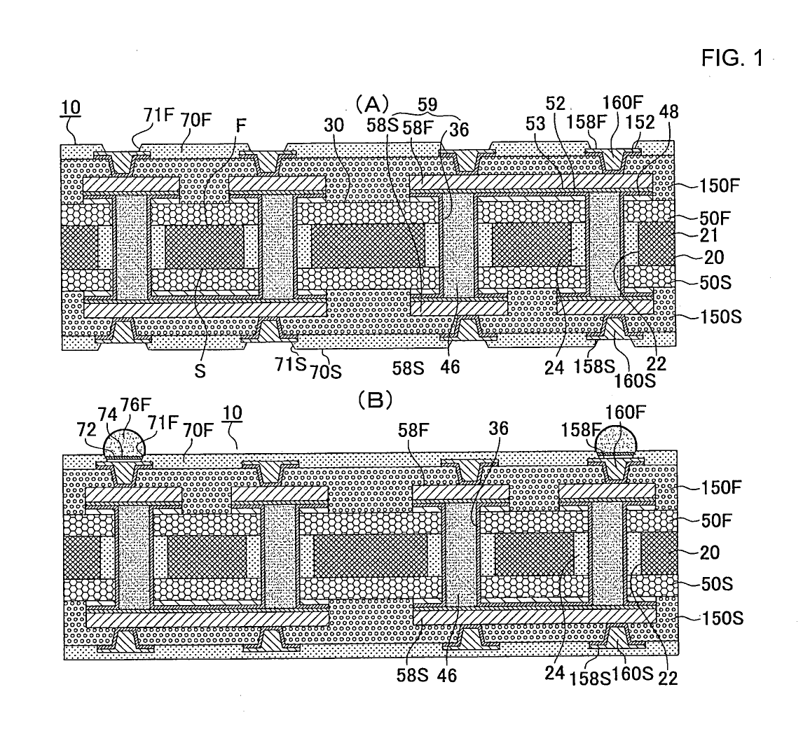

FIG. 1A is a cross-sectional view of an inductor device according to a first embodiment. The inductor device 10 has an inductor component 30 which includes a core base 20 that includes a magnetic layer 21 containing a magnetic material, a first conductive pattern (58F) formed on the side of a first surface (F) of the core base, a second conductive pattern (58S) formed on the side of a second surface (S) of the core base, and a through-hole conductor 36 connecting the first conductive pattern (58F) and the second conductive pattern (58S).

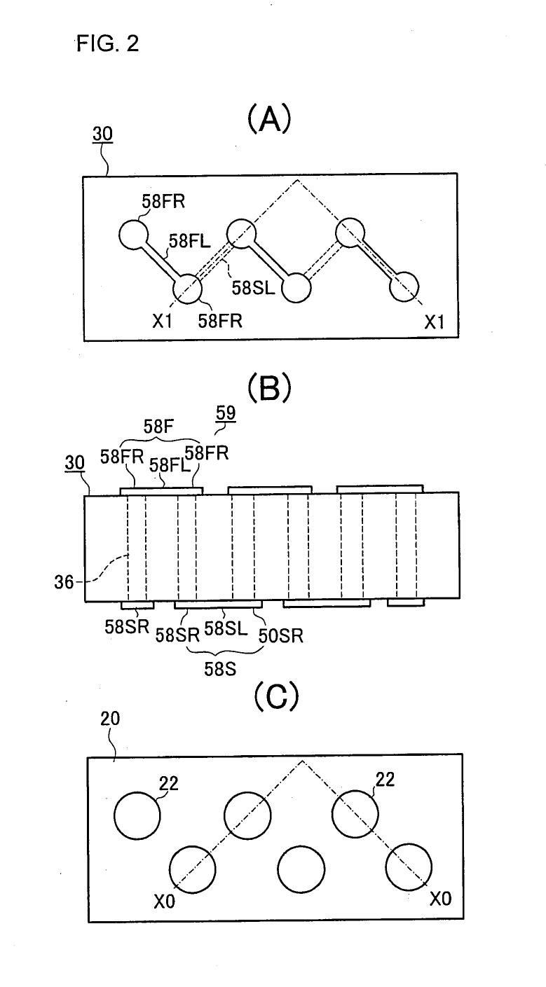

FIG. 2A is a plan view of the inductor component 30, and FIG. 2B is a side view of the same. The first conductive pattern (58F) on the side of the first surface includes a through-hole land (58FR) formed directly on the through-hole conductor 36 and a connecting pattern (58FL) that connects a through-hole land (58FR) and another through-hole land (58FR). The second conductive pattern (58S) on the side of the second surface includes a through-hole land (58SR) formed directly under the through-hole conductor 36 and a connecting pattern (58SL) that connects a through-hole land (58SR) and another through-hole land (58SR). The first conductive pattern (58F) and the second conductive pattern (58S) are arranged in a helical (spiral) form via the through-hole conductor 36, and an inductor 59 is formed by the first conductive pattern (58F), the second conductive pattern (58S) and the through-hole conductor 36.

FIG. 1A corresponds to a cross section when cutting is done along the (X1-X1) line shown in FIG. 2A. As shown in the figure, in the inductor component 30 of the inductor device, a resin insulation layer (50F) is formed on the first surface (F) of the core base 20, and the first conductive pattern (58F) is formed on the resin insulation layer (50F). A resin insulation layer (50S) is formed on the side of the second surface (S) of the core base 20, and the second conductive pattern (58S) is formed on the resin insulation layer (50S). The through-hole conductor 36 connecting the first conductive pattern (58F) and the second conductive pattern (58S) is formed inside a penetrating hole 22 formed on the core base 20 with an insulation layer 24 lying between the through-hole conductor 36 and the core base 20. A filling resin 46 is filled in the through-hole conductor 36.

An uppermost interlayer resin insulation layer (150F) is formed on the resin insulation layer (50F) and the first conductive pattern (58F), and a first conductive layer (158F) is formed on the uppermost interlayer resin insulation layer (150F), and so the first conductive pattern (58F) and the first conductive layer (158F) are connected via a via conductor (160F). A solder resist layer (70F) is formed on the uppermost interlayer resin insulation layer (150F) and the first conductive layer (158F), and the first conductive layer (158F) exposed from the aperture (71F) of the solder resist layer works as a pad.

A lowermost interlayer resin insulation layer (150S) is formed on the resin insulation layer (50S) and the second conductive pattern (58S), and the second conductive layer (158S) is formed on the lowermost interlayer resin insulation layer (150S), and so the second conductive pattern (58S) and the second conductive layer (158S) are connected by a via conductor (160S). A solder resist layer (70S) is formed on the lowermost interlayer resin insulation layer (150S) and the second conductive layer (158S), and the second conductive layer (158S) exposed from the aperture (71S) of the solder resist layer works as a pad.

In the inductor device of the first embodiment, the first conductive pattern (58F) and second conductive pattern (58S) located respectively on the front side and the back side of the core base 20 are arranged in a helical (spiral) form via the through-hole conductor 36 of the core base, forming an inductor component. Magnetic flux concentrates in a space surrounded by the first conductive pattern (58F) and the second conductive pattern (58S) which are arranged in a spiral form, and the magnetic material (the core base) 20 is present at this position where the magnetic flux concentrates. Thus, with magnetic flux density enhanced, desired inductance characteristics (an inductance value, a Q-value) can be obtained. Furthermore, since another magnetic material (core base) 20 is present on the outside of the spiral structure formed by the first conductive pattern (58F) and the second conductive pattern (58S), the leakage of magnetic flux is suppressed, and desired characteristics (an inductance value, a Q-value) are easily obtained. It is preferred that the magnetic material has magnetic permeability of 2 to 20 and magnetic saturation of 0.1 T to 2 T.

In the conductor device of the first embodiment, the conductive patterns (58F, 58S) are provided on the resin insulation layers (50F, 50S) on the core base 20. In this case, a conductive pattern is to be provided on a resin insulation layer. Therefore, as compared with a case where a conductive pattern comes in contact with a magnetic layer, the adhesion of the conductive pattern is more easily ensured.

In the inductor device of the first embodiment, a filling member 24 including a resin lies between the magnetic layer 20 and the through-hole conductor 36. With this measure, contact between the magnetic layer 20 and the through-hole conductor 36 is avoided. As a result, adhesion of the through-hole conductor is easily ensured.

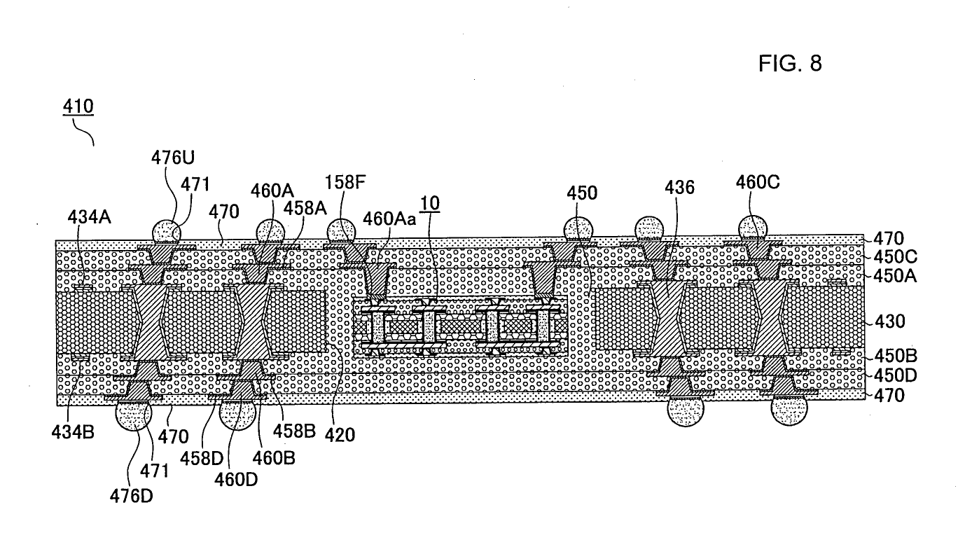

FIG. 8 shows a cross-sectional view of a printed wiring board 410 into which the inductor device of the first embodiment is built. The printed wiring board of the first embodiment has a core substrate 430 provided with an aperture 420. The inductor device 10 is accommodated in the aperture. A filling resin 450 is filled in the aperture 420. The core substrate 430 is provided with a through-hole conductor 436, and conductive patterns (434A, 434B) are formed. Formed on the core substrate 430 are an interlayer resin insulation layer (450A) provided with a conductive layer (458A) and a via conductor (460A), and an interlayer resin insulation layer (450B) provided with a conductive layer (458B) and a via conductor (460B). Formed in the interlayer resin insulation layer (450A) is a via conductor (460Aa), which is to be connected to the first conductive layer (158F) of the inductor device 10. On the interlayer resin insulation layer (450A), an uppermost interlayer resin insulation layer (450C) provided with a conductive layer (458C) and a via conductor (460C) is formed, and on the interlayer resin insulation layer (450B), a lowermost interlayer resin insulation layer (450D) provided with a conductive layer (458D) and a via conductor (460D) is formed. A solder resist layer 470 is formed on the uppermost interlayer resin insulation layer (450C), and a C4 solder bump (476U) for semiconductor device mounting is formed on the aperture 471 of the solder resist layer. The solder resist layer 470 is formed on the lowermost interlayer resin insulation layer (450D), and a BGA solder bump (476D) is formed on the aperture 471 of the solder resist layer.

### Method for Manufacturing Inductor Device of First Embodiment

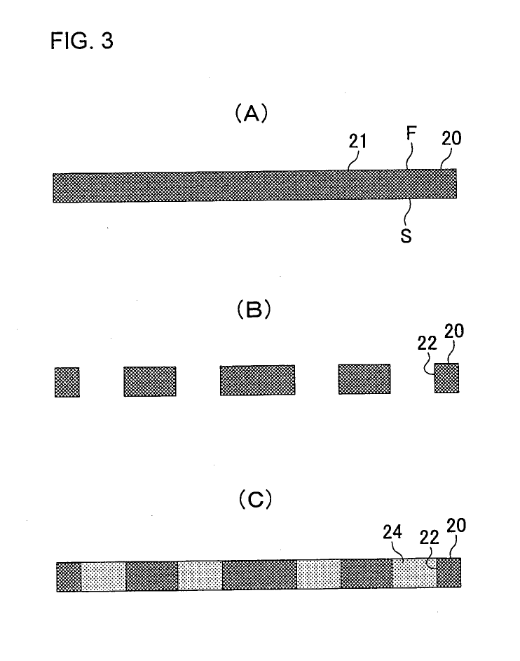

The method for manufacturing the inductor device of the first embodiment is shown in FIGS. 3˜7. The core base 20 including the magnetic layer 21 with a thickness of 0.1 mm to 0.5 mm is prepared. The magnetic sheet is composed of a resin that contains magnetic particles (FIG. 3A). The penetrating hole 22 is formed in an area where a through hole is to be formed in the core base 20 (FIG. 3B). A plan view of the core base 20 is shown in FIG. 2C. FIG. 3B corresponds to a cross section when cutting is done along the (X0-X0) line shown in FIG. 2C. A filling resin 24 is filled in the penetrating hole 22 (FIG. 3C).

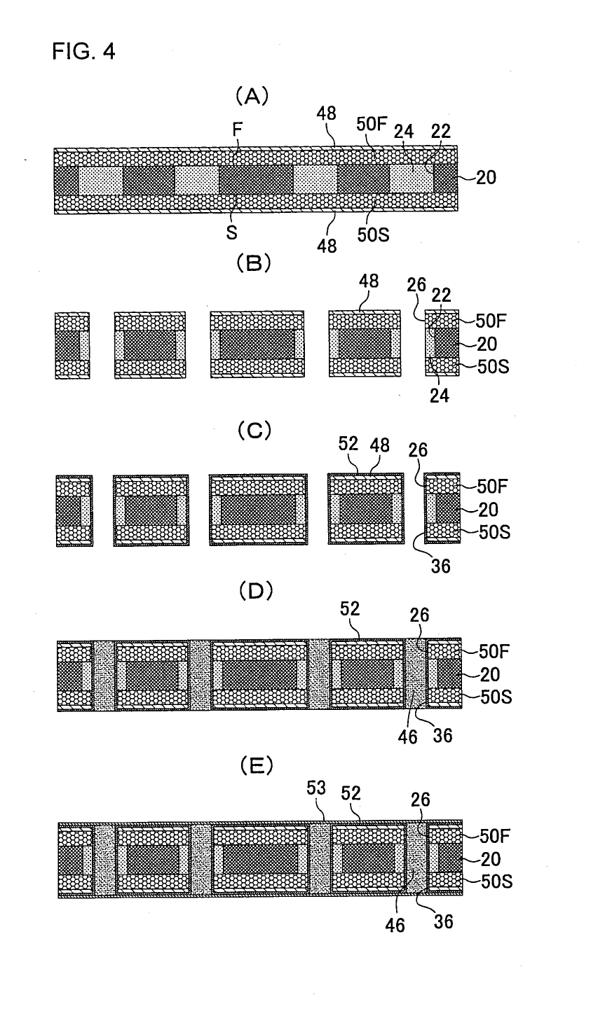

The resin insulation layer (50F) and a copper foil 48 are laminated on the first surface (F) of the core base 20, and a resin insulation layer (505) and a copper foil 48 are laminated on the second surface (S) (FIG. 4A). A penetrating hole 26 is formed in an area where a through hole is to be formed using a laser or a drill (FIG. 4B). The filling resin between the formed penetrating hole 26 and the penetrating hole 22 of the core base is used as the resin layer 24. On the copper foil 48 and on the inner wall of the penetrating hole 26, a plated film 52 is formed using electroless plating and electrolytic plating. The plated film 52 formed on the inner wall of the penetrating hole 26 forms the through-hole conductor 36 (FIG. 4C). A resin filler 46 is filled in the through-hole conductor 36 (FIG. 4D). An electroless-plated film 53 is formed on the plated film 52 and on the resin filler 46 exposed from the through-hole conductor (FIG. 4E).

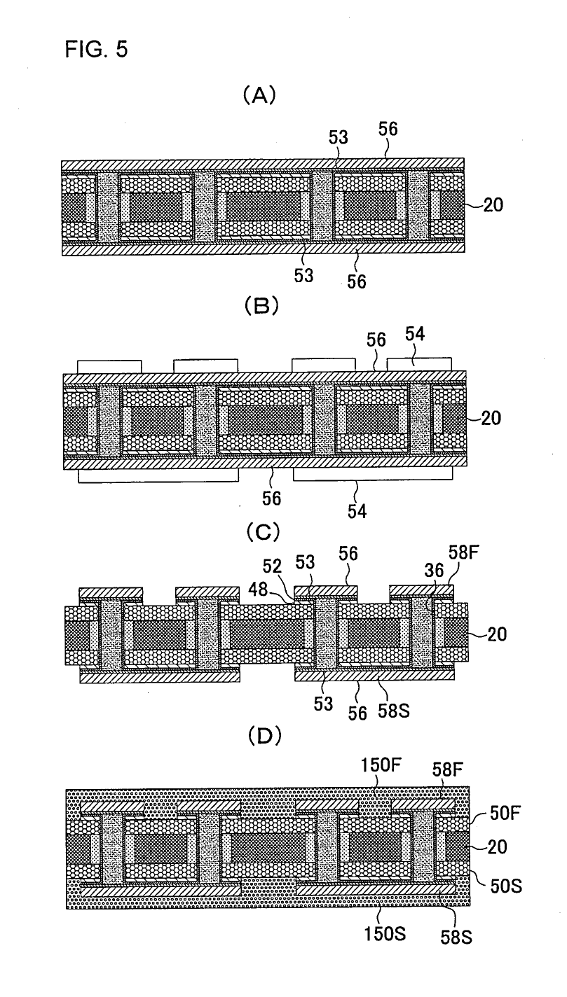

An electrolytic-plated film 56 is formed on the electroless-plated film 53 (FIG. 5A), and an etching resist 54 of a prescribed pattern is formed on the electrolytic-plated film 56 (FIG. 5B). Then, now that the electrolytic-plated film 56, the electroless-plated film 53, the plated film 52 and the copper foil 48, which are located in a part where the etching resist is not formed, have been exfoliated and the etching resist has been removed, the first conductive pattern (58F) and the second conductive pattern (58S) are formed (FIG. 5C). The uppermost interlayer resin insulation layer (150F) is formed on the resin insulation layer (50F) and the first conductive pattern (58F), and the lowermost interlayer resin insulation layer (150S) is formed on the resin insulation layer (50S) and the second conductive pattern (58S) (FIG. 5D).

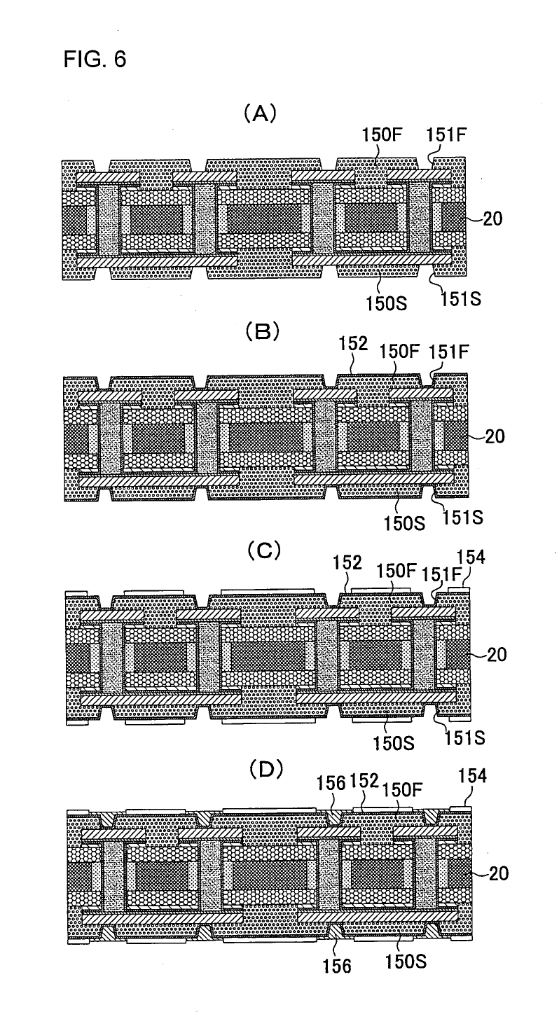

An aperture (151F) for a via hole is formed on the uppermost interlayer resin insulation layer (150F), and an aperture (151S) for a via hole is formed on the lowermost interlayer resin insulation layer (150S) (FIG. 6A). An electroless-plated film 152 is formed on the interlayer resin insulation layers (150F, 150S) (FIG. 6B). A plating resist 154 of a prescribed pattern is formed on the electroless-plated film 152 (FIG. 6C). An electrolytic-plated film 156 is formed on a part where a plating resist is not formed (FIG. 6D).

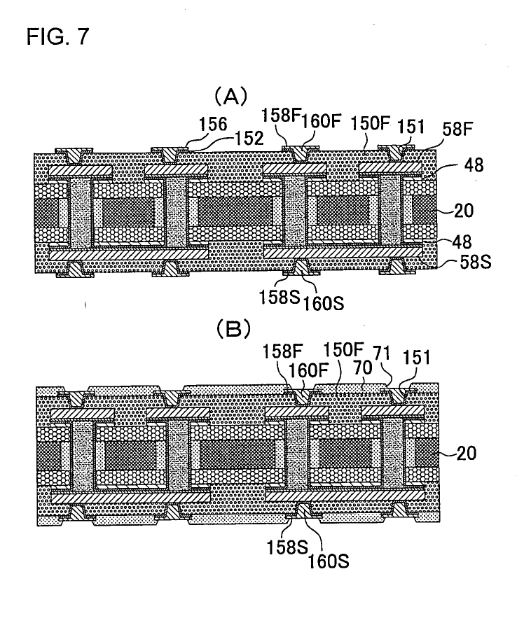

The plating resist being exfoliated and the electroless-plated film 152 located between the electrolytic-plated films 156 being removed, the first conductive layer (158F) is formed to include the electrolytic-plated film 156 and the electroless-plated film 152, the via conductor (160F), the second conductive layer (158S) and the via conductor (160S) (FIG. 7A). The thicknesses of the first conductive pattern (58F) and the second conductive pattern (58S), which are both provided with the copper foil 48, are thicker than the thicknesses of the first conductive layer (158F) and the second conductive layer (158S). For this reason, the resistance of the through-hole conductor of the inductor is kept from increasing, and a good inductance characteristic (a Q-value) is easily ensured. On the uppermost interlayer resin insulation layer (150F) and the lowermost interlayer resin insulation layer (150S), the solder resist layer 70 provided with the aperture 71 for forming a pad is formed, and the inductor device is completed (FIG. 7B). The inductor device of the first embodiment can be formed by a manufacturing method similar to that of a printed wiring board, which enables easy manufacturing.

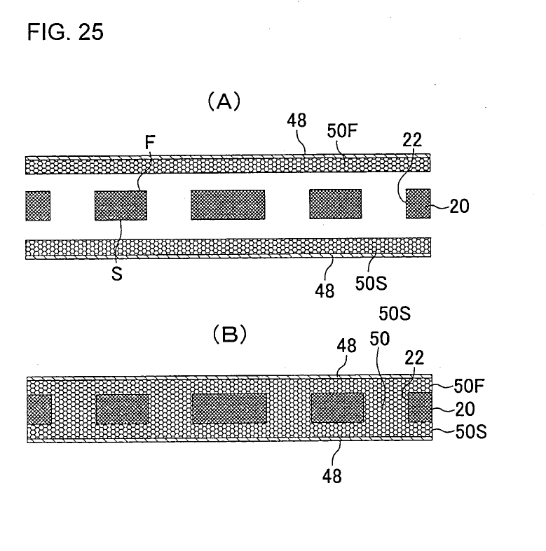

FIG. 25 is a process drawing showing the method for manufacturing an inductor device according to a modification of the first embodiment. In the modification of the first embodiment, after the penetrating hole 22 is formed on the core base 20 (FIG. 3B), the resin insulation layer (50F) and the copper foil 48 are laminated on the first surface (F) of the core base 20, and the resin insulation layer (50S) and the copper foil 48 are laminated on the second surface (S) (FIG. 25A). Then, while the lamination is performed, a resin 50 originating in the resin insulation layers (50F, 50S) is filled in the penetrating hole 22 (FIG. 25B). The subsequent processes are similar to those of the first embodiment.

In the modification of the first embodiment, the process of forming an insulation layer on a magnetic layer includes a penetrating hole, and a part of an insulation layer is to be filled in the penetrating hole 22. Accordingly, this process can be simplified, as compared with a process where a filling member is filled in the second penetrating hole and then an insulation layer is formed separately.

FIG. 1B shows the inductor device of the first embodiment for surface mounting. A solder bump (76F) is formed on the aperture (71F) of the solder resist layer (70F) via a nickel layer 72 and a gold layer 74.

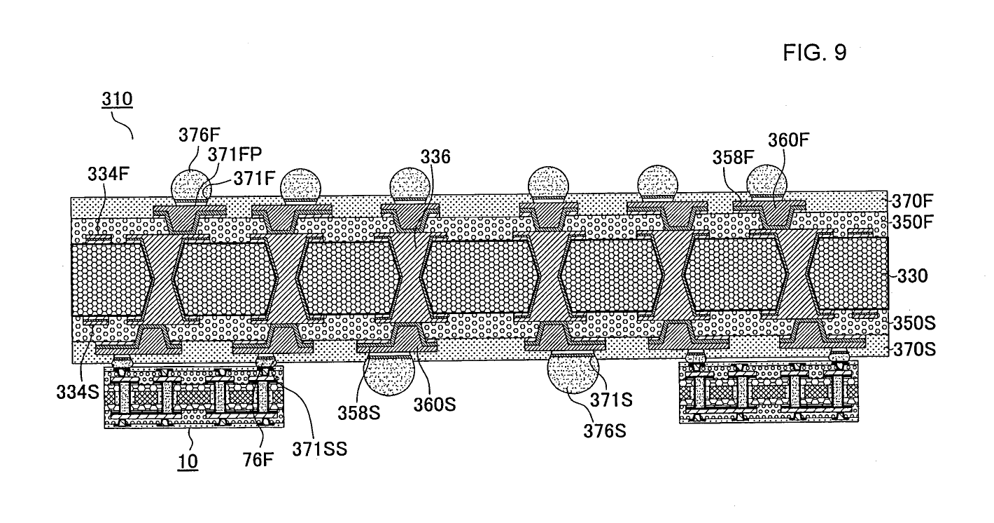

FIG. 9 shows a cross section of a printed wiring board 310 on which the inductor device of the first embodiment is mounted. The printed wiring board 310 of the first embodiment has a core substrate 330. The core substrate 330 is provided with a through-hole conductor 336, and conductive patterns (334F, 334S) are respectively formed on both sides of the core substrate 330. On the core substrate 330, an interlayer resin insulation layer (350F) provided with a conductive layer (358F) and a via conductor (360F), and an interlayer resin insulation layer (350S) provided with a conductive layer (358S) and a via conductor (360S) are formed. A solder resist layer (370F) is formed on the interlayer resin insulation layer (350F), and a C4 solder bump (376F) for semiconductor device mounting is formed on the aperture (371F) of the solder resist layer. A solder resist layer (370S) is formed on a interlayer resin insulation layer (350D), and a BGA solder bump (376S) for connection to a motherboard is formed on the aperture (371 S) of the solder resist layer. The solder bump (76F) of the inductor device 10 is connected via the aperture (371 S) of the solder resist layer.

When an inductor is formed within a printed wiring board, the difference in the ratio of the area of a conductor for the front and back surfaces of a core substrate increases due to the design of the inductor, and warping is likely to occur. However, when an inductor device is mounted on a printed wiring board, the problem mentioned above is not likely to occur, and the mountability of a semiconductor device is kept from deteriorating.

### Second Embodiment

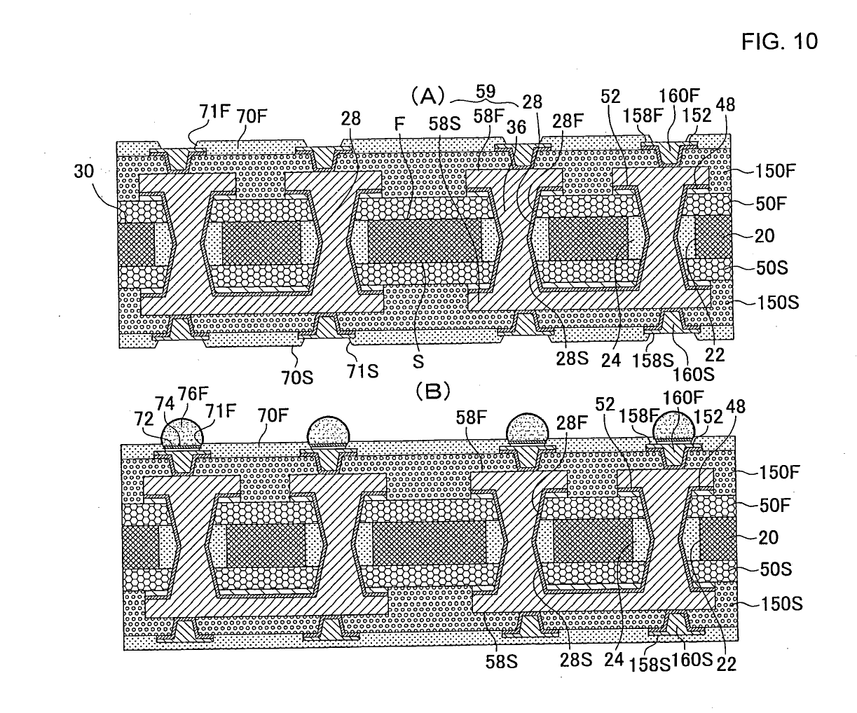

FIG. 10A is a cross-sectional view of the built-in inductor device of a printed wiring board according to a second embodiment. The inductor device is built into the core substrate of the printed wiring board in a manner similar to the first embodiment mentioned above with reference to FIG. 8. The inductor device 10 has an inductor component 30 which includes a core base 20 including a magnetic material, a first conductive pattern (58F) formed on the side of the first surface (F) of the core base, a second conductive pattern (58S) formed on the side of the second surface (S) of the core base, and a through-hole conductor 36 connecting the first conductive pattern (58F) and the second conductive pattern (58S).

In the inductor device of the second embodiment, in a manner similar to that of the first embodiment mentioned above with reference to FIG. 2, the first conductive pattern (58F) and the second conductive pattern (58S) are arranged in a helical (spiral) form via the through-hole conductor 36, and an inductor 59 is formed by the first conductive pattern (58F), the second conductive pattern (58S) and the through-hole conductor 36.

In the inductor component 30 of the inductor device, a resin insulation layer (50F) is formed on the first surface (F) of the core base 20, and the first conductive pattern (58F) is formed on the resin insulation layer (50F). A resin insulation layer (50S) is formed on the second surface (S) of the core base 20, and the second conductive pattern (58S) is formed on the resin insulation layer (50S). The through-hole conductor 36 connecting the first conductive pattern (58F) and the second conductive pattern (58S) is formed in a penetrating hole 22 formed on the core base 20 with an insulation layer 24 lying between the through-hole conductor 36 and the core base 20. The through-hole conductor 36 is formed by filling a plating substance in a penetrating hole 28 in the insulation layer 24. For this reason, the resistance of the through-hole conductor forming the inductor is kept from increasing, and a good inductor characteristic (a Q-value) is easily ensured.

An uppermost interlayer resin insulation layer (150F) is formed on the resin insulation layer (50F) and the first conductive layer pattern (58F), and a first conductive layer (158F) is formed on the uppermost interlayer resin insulation layer (150F), and so the first conductive pattern (58F) and the first conductive layer (158F) are connected by a via conductor (160F). A solder resist layer (70F) is formed on the uppermost interlayer resin insulation layer (150F) and the first conductive layer (158F), and the first conductive layer (158F) exposed from the aperture (71F) of the solder resist layer works as a pad.

A lowermost interlayer resin insulation layer (150S) is formed on the resin insulation layer (50S) and the second conductive pattern (58S), and a second conductive layer (158S) is formed on the lowermost interlayer resin insulation layer (150S), and so the second conductive pattern (58S) and the second conductive layer (158S) are connected by a via conductor (160S). A solder resist layer (70S) is formed on the lowermost interlayer resin insulation layer (150S) and the second conductive layer (158S), and a second conductive layer (158S) exposed from the aperture (71 S) of the solder resist layer works as a pad.

### Method for Manufacturing Inductor Device of Second Embodiment

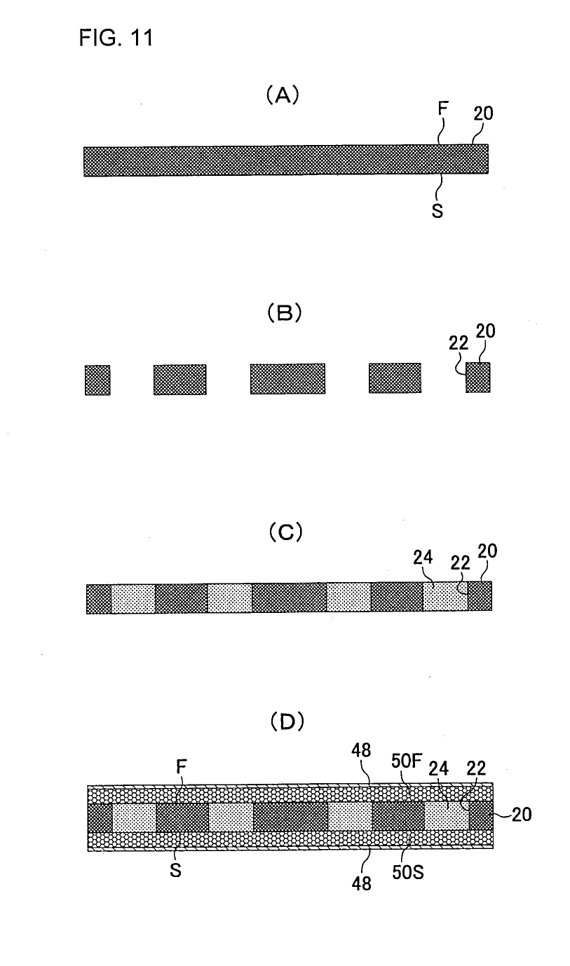

The method for manufacturing the inductor device of the second embodiment is shown in FIGS. 11˜15. The core base 20 including a magnetic sheet with a thickness of 0.1 mm to 0.5 mm is prepared. The magnetic sheet is made of a resin that contains magnetic particles (FIG. 11A). The penetrating hole 22 is formed where a through hole is to be formed in the core base 20 (FIG. 11B). A plan view of the core base 20 is similar to that of the first embodiment mentioned above with reference to FIG. 2C. A filling resin 24 is filled in the penetrating hole 22 (FIG. 11C). The resin insulation layer (50F) and a copper foil 48 are laminated on the first surface (F) of the core base, and the resin insulation layer (50S) and a copper foil 48 are laminated on the second surface (S) of the core base (FIG. 11D).

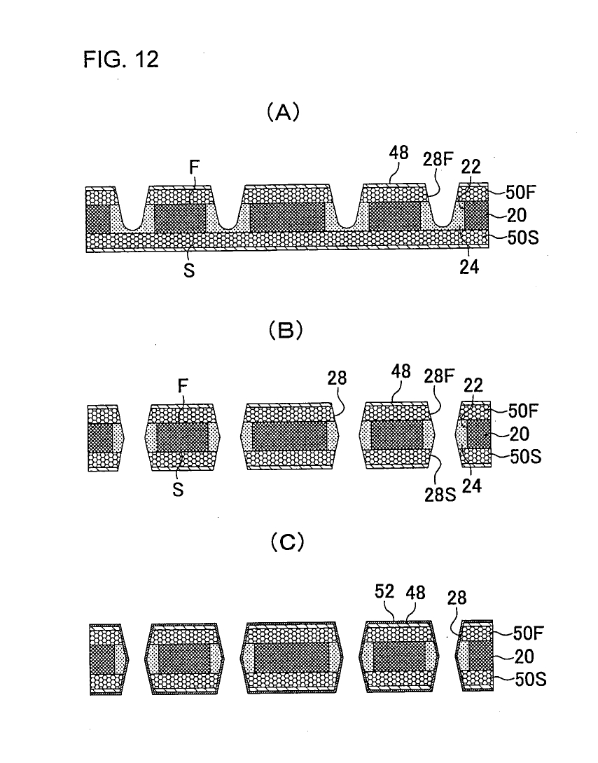

An aperture (28F) is formed where a through hole is to be formed from the side of the first surface (F) using a laser (FIG. 12A). An aperture (28S) is formed where a through hole is to be formed from the side of the second surface (S) using the laser, and so a penetrating hole 28 with an hourglass shape is completed (FIG. 12B). A plated film 52 is formed on a copper foil 44 and on the inner wall of the penetrating hole 28 (FIG. 12C).

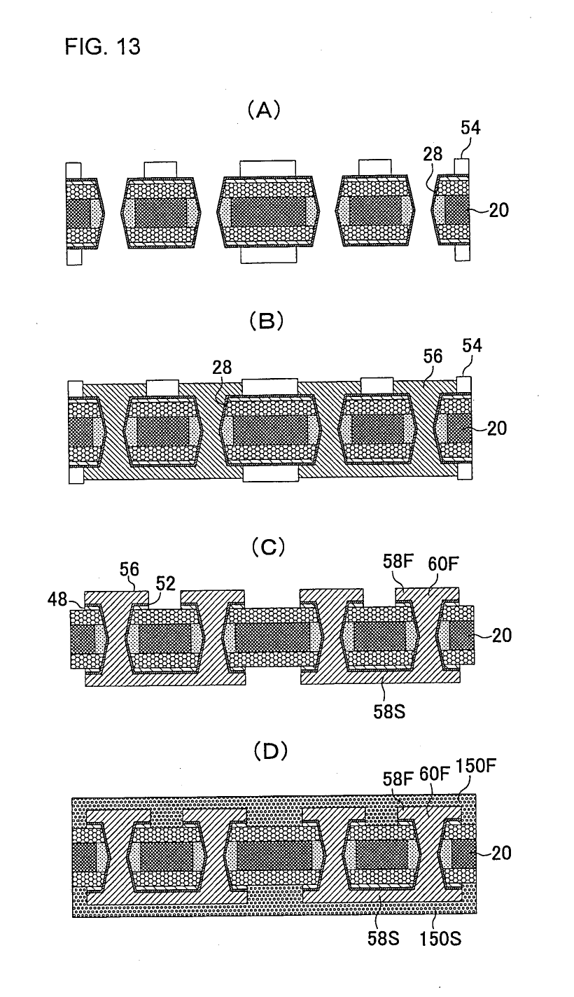

A plating resist 54 of a prescribed pattern is formed on the plated film 52 (FIG. 13A), and an electrolytic-plated film 56 is formed on a part where a plating resist is not formed (FIG. 13B). Now that the plating resist has been exfoliated and the plating film 52 located between the electrolytic-plated films has been removed, and also with the copper foil 48 removed, the first conductive pattern (58F) and the second conductive pattern (58S) are formed (FIG. 13C). The uppermost interlayer resin insulation layer (150F) is formed on the resin insulation layer (50F) and the first conductive pattern (58F), and the lowermost interlayer resin insulation layer (150S) is formed on the resin insulation layer (50S) and the second conductive pattern (58S) (FIG. 13D).

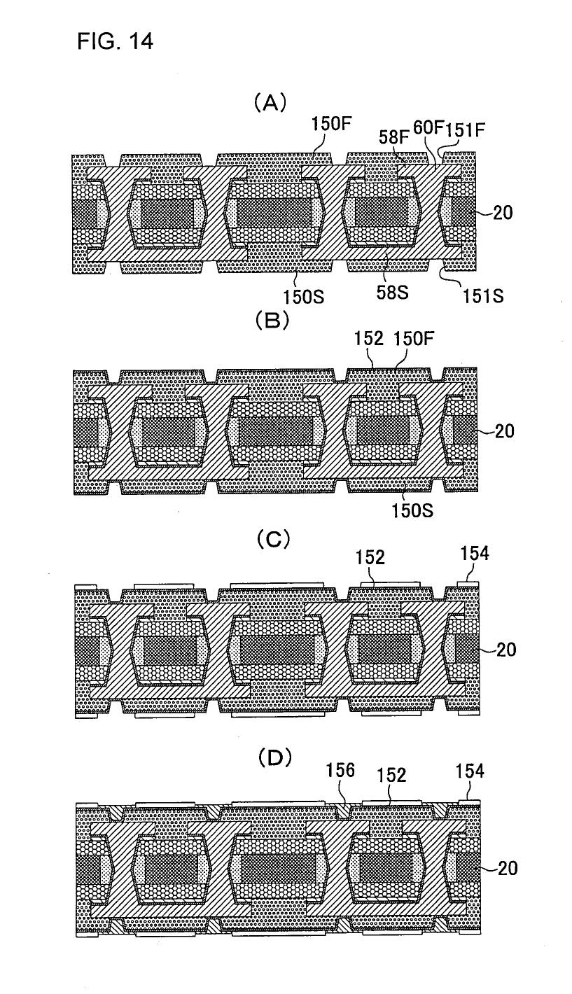

An aperture (151F) for a via hole is formed on the uppermost interlayer resin insulation layer (150F), and an aperture (151S) for a via hole is formed on the lowermost interlayer resin insulation layer (150S) (FIG. 14A). An electroless-plated film 152 is formed on the interlayer resin insulation layers (150F, 150S) (FIG. 14B). A plating resist 154 of a prescribed pattern is formed on the electroless-plated film 152 (FIG. 14C). An electrolytic-plated film 156 is formed on a part where a plating resist is not formed (FIG. 14D).

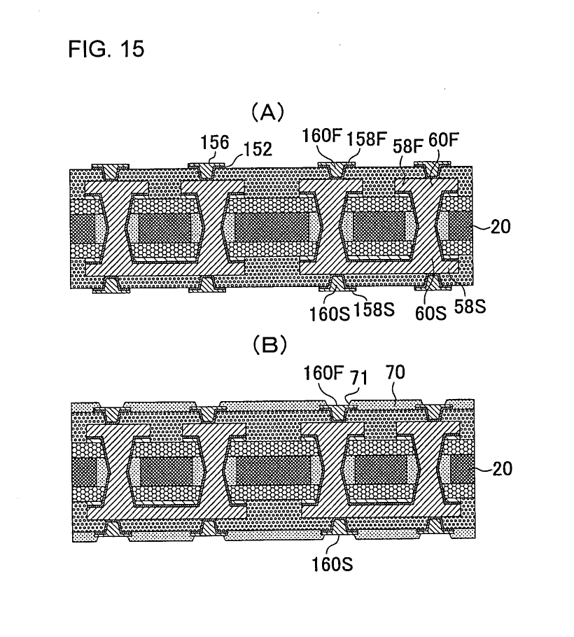

The plating resist being exfoliated and the electroless-plated film 152 located between the electrolytic-plated films 156 being removed, the first conductive layer (158F) is formed to include the electrolytic-plated film 156 and the electroless-plated film 152, the via conductor (160F), the second conductive layer (158S) and the via conductor (160S) (FIG. 15A). On the uppermost interlayer resin insulation layer (150F) and the lowermost interlayer resin insulation layer (150S), the solder resist layer 70 provided with the aperture 71 for forming a pad is formed, and the inductor device is completed (FIG. 15B).

FIG. 10B shows the inductor device of the second embodiment for surface mounting. A solder bump (76F) is formed on the aperture (71F) of the solder resist layer (70F) via a nickel layer 72 and a gold layer 74. The inductor device of the second embodiment shown in FIG. 10B is mounted on the printed wiring board in a manner similar to that of the first embodiment mentioned above with reference to FIG. 9.

### Third Embodiment

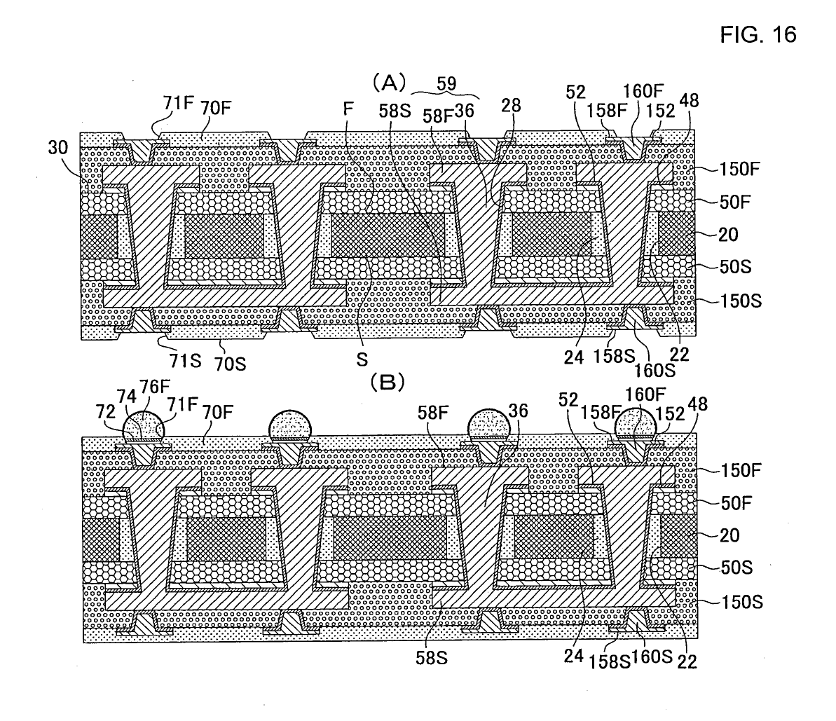

FIG. 16A is a cross-sectional view of the built-in inductor device of a printed wiring board according to a third embodiment. The inductor device is built into the core substrate of the printed wiring board in a manner similar to that of the first embodiment mentioned above with reference to FIG. 8. The inductor device 10 has an inductor component 30 which includes a core base 20 including a magnetic material, a first conductive pattern (58F) formed on the side of the first surface (F) of the core base, a second conductive pattern (58S) formed on the side of the second surface (S) of the core base, and a through-hole conductor 36 connecting the first conductive pattern (58F) and the second conductive pattern (58S).

In the inductor device of the third embodiment, in a manner similar to that of the first embodiment mentioned above with reference to FIG. 2, the first conductive pattern (58F) and the second conductive pattern (58S) are arranged in a helical (spiral) form via the through-hole conductor 36, and an inductor 59 is formed by the first conductive pattern (58F), the second conductive pattern (58S) and the through-hole conductor 36. The inductor device of the third embodiment is similar to the inductor device of the second embodiment except that the through-hole conductor 36 has a truncated-conical shape.

### Method for Manufacturing Inductor Device of Third Embodiment

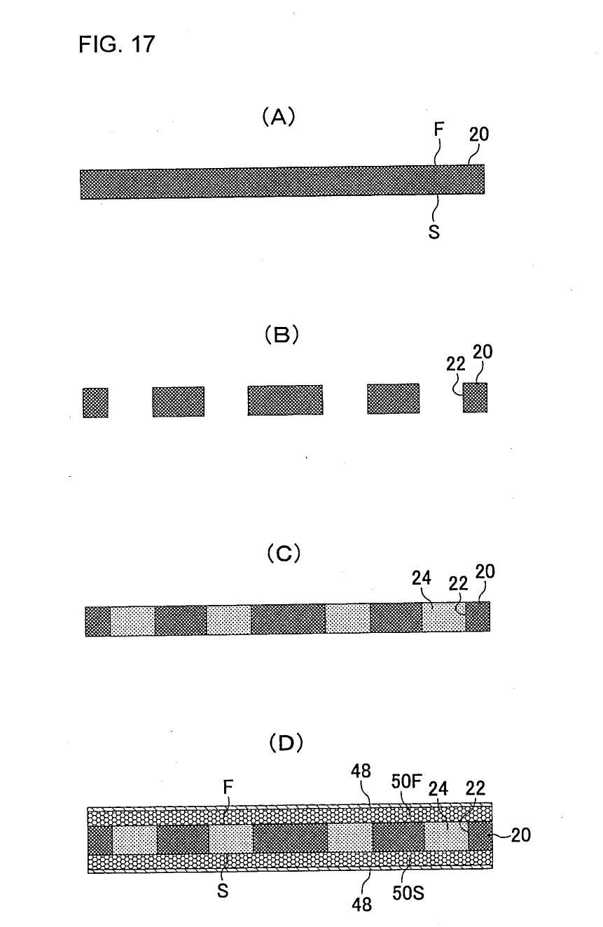

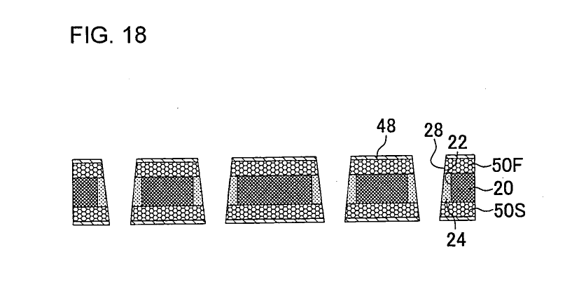

The method for manufacturing the inductor device of the third embodiment is shown in FIGS. 17 and 18. The core base 20 including a magnetic sheet with the thickness of 0.1 mm to 0.5 mm is prepared (FIG. 17A). A penetrating hole 22 is formed in an area where a through hole is to be formed in the core base 20 (FIG. 17B). A plan view of the core base 20 is similar to that of the first embodiment mentioned above with reference to FIG. 2C. A filling resin 24 is filled in the penetrating hole 22 (FIG. 17C). A resin insulation layer (50F) and a copper foil 48 are laminated on the first surface (F) of the core base, and a resin insulation layer (50S) and a copper foil 48 are laminated on the second surface (S) of the core base (FIG. 17D).

A penetrating hole 28 with a truncated-conical shape, the diameter of which decreases toward the side of the resin insulation layer (50S), is formed by a laser from the side of first surface (F) (FIG. 18). Explanations will be omitted for the subsequent processes, because they are similar to those of the second embodiment mentioned above with reference to FIGS. 12B˜15B.

FIG. 16B shows the inductor device of the third embodiment for surface mounting. A solder bump (76F) is formed on the aperture (71 F) of a solder resist layer (70F) via a nickel layer 72 and a gold layer 74. The inductor device shown in FIG. 16B is mounted on the printed wiring board in a manner similar to that of the first embodiment mentioned above with reference to FIG. 9.

### Fourth Embodiment

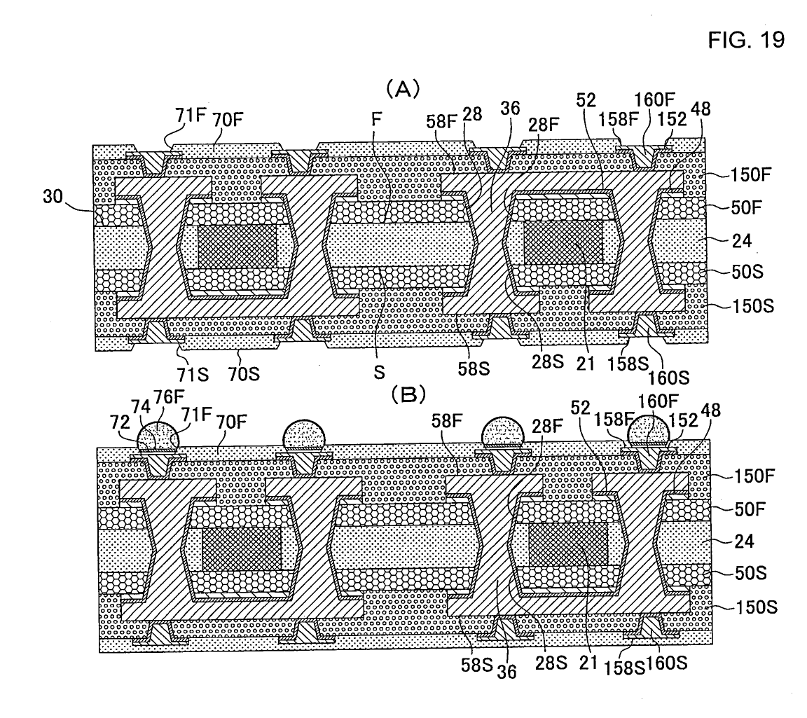

FIG. 19A is a cross-sectional view of an inductor device according to a fourth embodiment. The inductor device 10 has an inductor component 30 which includes a core base 24 having a built-in magnetic substance 21 including a magnetic material, a first conductive pattern (58F) formed on the side of the first surface (F) of the core base, a second conductive pattern (58S) formed on the side of the second surface (S) of the core base, and a through-hole conductor 36 connecting the first conductive pattern (58F) and the second conductive pattern (58S).

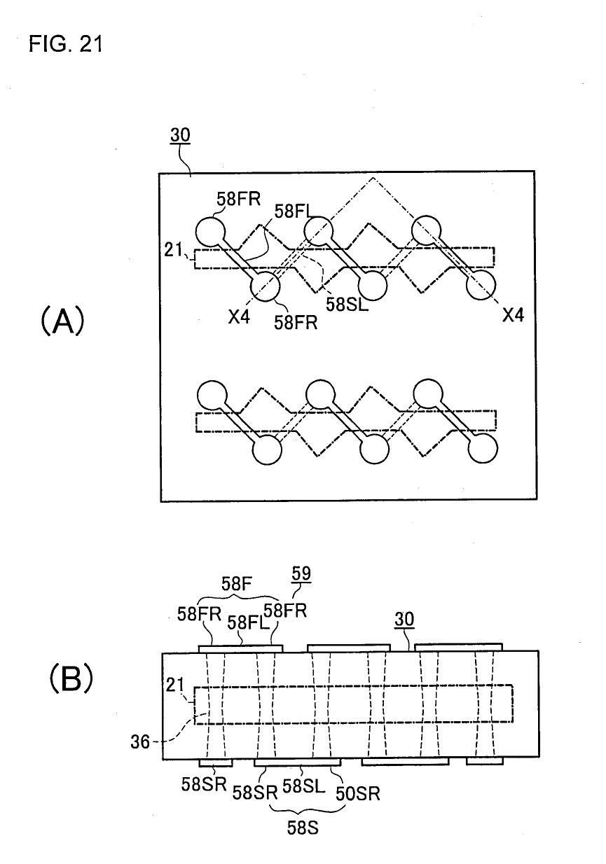

FIG. 21A is a plan view of the inductor component 30, and FIG. 21B is a side view of the inductor component 30. The first conductive pattern (58F) on the side of the first surface includes a through-hole land (58FR) formed directly on the through-hole conductor 36 and a connecting pattern (58FL) that connects a through-hole land (58FR) and another through-hole land (58FR). The second conductive pattern (58S) on the side of the second surface includes a through-hole land (58SR) formed directly under the through-hole conductor 36 and a connecting pattern (58SL) that connects a through-hole land (58SR) and another through-hole land (58SR). The first conductive pattern (58F) and the second conductive pattern (58S) are arranged in a helical (spiral) form around a rod-shaped magnetic substance 21 via the through-hole conductor 36, and an inductor 59 is formed by the magnetic substance 21, the first conductive pattern (58F), the second conductive pattern (58S) and the through-hole conductor 36.

FIG. 19A corresponds to a cross section when cutting is done along the (X4-X4) line shown in FIG. 21A. In the inductor component 30 of the inductor device, as shown in the figure, a resin insulation layer (50F) is formed on the first surface (F) of the core base 24, and the first conductive pattern (58F) is formed on the resin insulation layer (50F). The resin insulation layer (50S) is formed on the side of the second surface (S) of the core base 24, and the second conductive pattern (58S) is formed on the resin insulation layer (50S). The through-hole conductor 36 connecting the first conductive pattern (58F) and the second conductive pattern (58S) is formed by filling a plating substance in a penetrating hole 28 formed on the core base 24.

An uppermost interlayer resin insulation layer (150F) is formed on the resin insulation layer (50F) and the first conductive pattern (58F), and the first conductive layer (158F) is formed on the uppermost interlayer resin insulation layer (150F), and so the first conductive pattern (58F) and the first conductive layer (158F) are connected by a via conductor (160F). A solder resist layer (70F) is formed on the uppermost interlayer resin insulation layer (150F) and the first conductive layer (158F), and the first conductive layer (158F) exposed from the aperture (71F) of the solder resist layer works as a pad.

A lowermost interlayer resin insulation layer (150S) is formed on the resin insulation layer (505) and the second conductive pattern (58S), and the second conductive layer (158S) is formed on the lowermost interlayer resin insulation layer (150S), and so the second conductive pattern (58S) and the second conductive layer (158S) are connected by a via conductor (160S). A solder resist layer (70S) is formed on the lowermost interlayer resin insulation layer (150S) and the second conductive layer (158S), and the second conductive layer (158S) exposed from the aperture (71 S) of the solder resist layer works as a pad.

### Method for Manufacturing Inductor Device of Fourth Embodiment

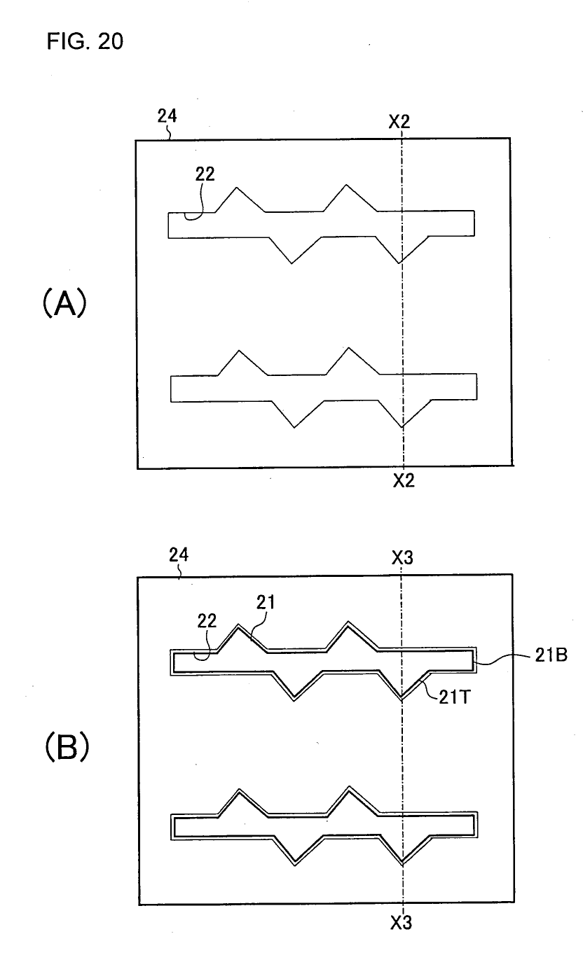

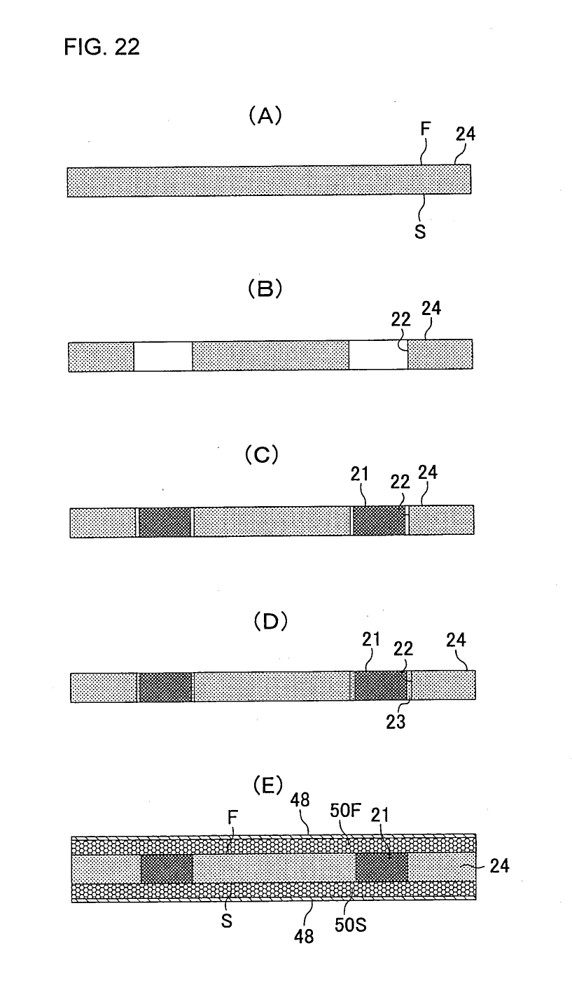

The method for manufacturing the inductor device of the fourth embodiment is shown in FIGS. 21 and 22. The core base 24 including a resin sheet with the thickness of 0.1 mm to 0.5 mm is prepared (FIG. 22A). A penetrating hole 22 with a shape corresponding to the shape of a magnetic substance is formed in a region of the core base 24 (FIG. 22B) where the magnetic substance is accommodated. A plan view of the core base 24 is shown in FIG. 20A. FIG. 22B corresponds to a cross section when cutting is done along the (X2-X2) line shown in FIG. 20A. A rod-shaped magnetic substance 21 is accommodated in the penetrating hole 22 (FIG. 22C). A plan view of the area of the core base 24 where the magnetic substance is accommodated is shown in FIG. 20B. FIG. 22C corresponds to a cross section when cutting is done along the (X3-X3) line shown in FIG. 20B. The magnetic substance 21 includes a prism part (21B) with a prismatic shape and a projection part (21T) which projects laterally and which has a triangular-shaped horizontal cross section. A filling resin 23 is filled in the gap between the penetrating hole 22 and the magnetic substance 21 (FIG. 22D). The resin insulation layer (50F) and a copper foil 48 are laminated on the first surface (F) of the core base, and the resin insulation layer (50S) and a copper foil 48 are laminated on the second surface (S) of the core base (FIG. 22E).

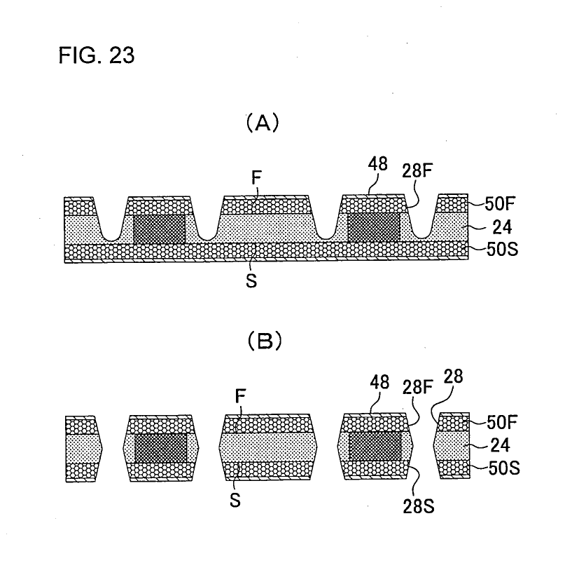

An aperture (28F) is formed in a position where a through hole is to be formed from the side of the first surface (F) using a laser (FIG. 23A). An aperture (28S) is formed in a position where a through hole is to be formed from the side of the second surface (S) using the laser, and so a penetrating hole 28 with an hourglass shape is completed (FIG. 23B). Explanations will be omitted for the subsequent processes, because they are similar to those of the second embodiment mentioned above with reference to FIGS. 12C˜15B.

FIG. 19B shows the inductor device of the fourth embodiment for surface mounting. A solder bump (76F) is formed on the aperture (71F) of the solder resist layer (70F) via a nickel layer 72 and a gold layer 74. The inductor device shown in FIG. 19B is mounted on a printed wiring board in a manner similar to that of the first embodiment mentioned above with reference to FIG. 9.

Although the through-hole conductor of the fourth embodiment is formed similarly to that of the second embodiment, it could be formed similarly to that of the first embodiment or of the third embodiment.

### Fifth Embodiment

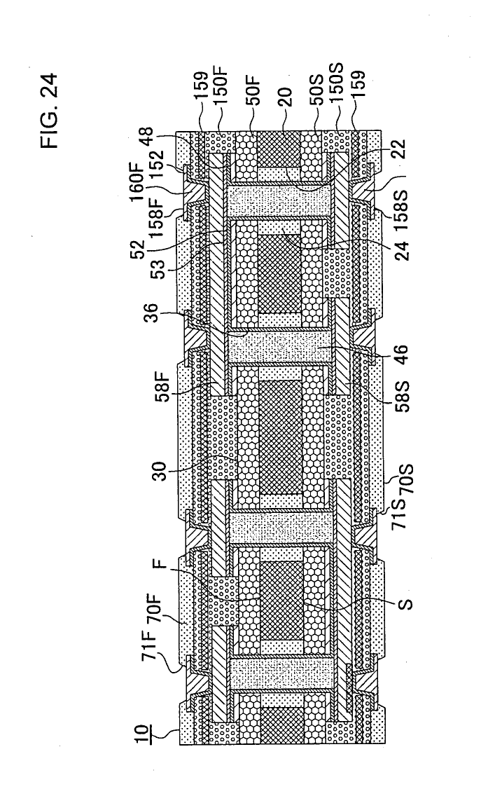

FIG. 24 is a cross section of an inductor device according to a fifth embodiment. The inductor device of the fifth embodiment is similar to the inductor device of the first embodiment. The inductor device of the fifth embodiment is provided with a magnetic layer 159 in the inner part of the uppermost interlayer resin insulation layer (150F) and lowermost interlayer resin insulation layer (150S).

In the inductor device of the fifth embodiment, the influence of lines of magnetic force on a conductor provided in the inner part of a buildup layer can also be reduced. Therefore, the electrical properties of the conductor provided in the inner part of the buildup layer are hardly impeded. Although the magnetic layer 159 is provided in the inner part of the uppermost interlayer resin insulation layer (150F) and the lowermost interlayer resin insulation layer (150S) in the fifth embodiment, magnetic particles could also be contained in an interlayer resin insulation layer.

In case a magnetic substance is present only inside a coil, when lines of magnetic force generated with current flowing in an inductor pass through a surrounding conductor, induced current is generated, and the induced current may affect the operation of a circuit. Furthermore, since magnetic flux generated from a coil pattern leaks to the outside of the coil, it is difficult to obtain desired inductance characteristics (an inductance value, a Q-value) for the electrical properties of the surrounding conductor. In addition, when the magnetic substance is formed by plating, dispersion may arise in the volume of the magnetic substance due to dispersion in the thickness of the plating substance and the like. It is thought that constant inductance characteristics are difficult to obtain due to dispersion in the volume of the magnetic substance.

According to an embodiment of the present invention, an inductor device obtains desired inductance characteristics (an inductance value, a Q-value), and according to another embodiment of the present invention, a printed wiring board includes such an inductor device.

According to an embodiment of the present invention, an inductor device includes a core base having a first surface, a second surface opposite the first surface, and a penetrating hole, a first conductive pattern formed on the first surface of the core base, a second conductive pattern formed on the second surface of the core base, and a through-hole conductor formed inside the penetrating hole and connecting the first conductive pattern and the second conductive pattern. The core base includes a magnetic material, and the first conductive pattern and the second conductive pattern are arranged in a helical form via the through-hole conductor.

By providing a magnetic layer in at least one part of the periphery of an inductor, the leakage of lines of magnetic force is suppressed as much as possible, and at least influence on a conductor located near the magnetic layer can be reduced. As a result, the electrical properties of a surrounding conductor are hardly impeded. In addition, by suppressing the leakage of lines of magnetic force, desired inductor characteristics are easily ensured.

Obviously, numerous modifications and variations of the present invention are possible in light of the above teachings. It is therefore to be understood that within the scope of the appended claims, the invention may be practiced otherwise than as specifically described herein.

What is claimed is:

1. An inductor device, comprising:
a core base; and
an inductor structure comprising a first conductive pattern formed on a first surface side of the core base, a second conductive pattern formed on a second surface side of the core base on an opposite side with respect to the first surface side of the core base, and a through-hole conductor formed through the core base such that the through-hole conductor is connecting the first conductive pattern and the second conductive pattern,
wherein the core base includes a magnetic material layer comprising a magnetic material, and the magnetic material layer of the core base is positioned adjacent to at least a portion of a periphery of the inductor structure.

2. An inductor device according to claim 1, wherein the magnetic material has a magnetic permeability in a range of from 2 to 20 and a magnetic saturation in a range of from 0.1 T to 2 T.

3. An inductor device according to claim 1, wherein the core base includes a first resin insulation layer formed on a first surface of the magnetic material layer and a second resin insulation layer formed on a second surface of the magnetic material layer on an opposite side with respect to the first surface of the magnetic material layer.

4. An inductor device according to claim 1, wherein the core base has a thickness in a range of from 0.1 mm to 0.5 mm.

5. An inductor device according to claim 1, further comprising:
a buildup layer formed on the first surface side of the core base and the first conductive pattern and comprising an interlayer resin insulation layer and a conductive layer formed on the interlayer resin insulation layer,
wherein the first conductive pattern has a thickness which is greater than a thickness of the conductive layer in the buildup layer.

6. An inductor device according to claim 5, wherein the interlayer resin insulation layer includes a magnetic material.

7. An inductor device according to claim 1, wherein the through-hole conductor comprises a plating material filling a penetrating hole formed through the core base.

8. An inductor device according to claim 3, wherein the through-hole conductor is formed in a penetrating hole formed through the first resin insulation layer, the magnetic material layer and the second resin insulation layer, and the penetrating hole has a filler material comprising a resin material and filling a space formed between the penetrating hole and the through-hole conductor.

9. An inductor device according to claim 8, wherein the resin material of the filler material is derived from a portion of at least one of the first resin insulation layer and the second resin insulation layer.

10. An inductor device according to claim 1, wherein the through-hole conductor is formed in a penetrating hole formed through the magnetic material layer, and the penetrating hole has a filler material comprising a resin material and filling a space formed between the penetrating hole and the through-hole conductor.

11. An inductor device according to claim 1, wherein the first conductive pattern, the through-hole conductor and the second conductive pattern are positioned such that the inductor structure has a helical form.

12. An inductor device according to claim 11, wherein the through-hole conductor is formed in a penetrating hole formed through the magnetic material layer, and the penetrating hole has a filler material comprising a resin material and filling a space formed between the penetrating hole and the through-hole conductor.

13. An inductor device according to claim 1, wherein the inductor structure comprises the through-hole conductor formed in a plurality.

14. A printed circuit board, comprising:
an outer insulation layer having a plurality of bump structures; and
an inductor device of claim 1 mounted to the outer insulation layer through the bump structure.

15. A printed circuit board, comprising:
a core substrate having an opening portion;
an inductor device of claim 1 accommodated in the opening portion of the core substrate.

16. A method for manufacturing an inductor device, comprising:
preparing a magnetic material layer comprising a magnetic material;
forming a penetrating hole through the magnetic material layer;
filling a filler material into the penetrating hole;
forming a first insulation layer on a first surface of the magnetic material layer;
forming a second insulation layer on a second surface of the magnetic material layer on an opposite side of the first surface of the magnetic material layer such that a core base comprising the first insulation layer, the magnetic material layer and the second insulation layer is formed;
forming a penetrating hole penetrating through the first insulation layer, the filler material filling the penetrating hole formed through the magnetic material layer, and the second insulation layer;
forming a first conductive pattern on a first surface side of the core base;
forming a second conductive pattern on a second surface side of the core base on an opposite side with respect to the first surface side of the core base; and
forming a through-hole conductor in the penetrating hole formed through the core base such that an inductor structure comprising the first conductive pattern, the second conductive pattern and the through-hole conductor connecting the first conductive pattern and the second conductive pattern is formed.

17. A method for manufacturing an inductor device according to claim 16, wherein the forming of the through-hole conductor comprises filling a plating material into the penetrating hole formed through the core base such that the plating material of the through-hole conductor connects the first conductive pattern and the second conductive pattern.

18. A method for manufacturing an inductor device according to claim 16, wherein the first conductive pattern, the through-hole conductor and the second conductive pattern are positioned such that the inductor structure has a helical form.

19. A method for manufacturing an inductor device according to claim 16, wherein the filling of the filler material and at least one of the forming of the first insulation layer and the forming of the second insulation layer are carried out in a same process such that the filler material is derived from a portion of at least one of the first insulation layer and the second insulation layer.

20. A method for manufacturing an inductor device according to claim 16, wherein the magnetic material has a magnetic permeability in a range of from 2 to 20 and a magnetic saturation in a range of from 0.1 T to 2 T.
